(19) United States
(12) Patent Application Publication
(10) Pub. No.: US 2013/0107184 A1
(43) Pub. Date: May 2, 2013

(54) LIQUID CRYSTAL DISPLAY

(71) Applicants: Norihisa MAEDA, Nonoichi-shi (JP); Kazuhiro NISHIYAMA, Kanazawa-shi (JP); Shigesumi ARAKI, Hakusan-shi (JP); Nami UYAMA, Hakusan-shi (JP); Tatsuya WAKIMOTO, Hakusan-shi (JP)

(72) Inventors: Norihisa MAEDA, Nonoichi-shi (JP); Kazuhiro NISHIYAMA, Kanazawa-shi (JP); Shigesumi ARAKI, Hakusan-shi (JP); Nami UYAMA, Hakusan-shi (JP); Tatsuya WAKIMOTO, Hakusan-shi (JP)

(21) Appl. No.: 13/666,277

(22) Filed: Nov. 1, 2012

(30) Foreign Application Priority Data
Nov. 1, 2011 (JP) 2011-240271

(51) Int. Cl. G02F 1/1343

(52) U.S. Cl. 349/141

(57) ABSTRACT

According to one embodiment, a display includes a first substrate including a scan line, a signal line crossing the scan line, a pixel electrode including first electrodes extending in a direction in which the signal line extends and arranged side by side in the direction in which the scan line extends, a common electrode including second electrodes extending in the direction in which the signal line extends between the first electrodes and arranged with a predetermined space to the first electrodes, and a shielding portion arranged at least between the signal line and the first electrodes arranged near the signal line and to which a same voltage as that of the common electrode is applied, second substrate arranged opposite to the first substrate, and a liquid crystal layer.

### CROSS-REFERENCE TO RELATED APPLICATIONS

This application is based upon and claims the benefit of priority from Japanese Patent Application No. 2011-240271, filed Nov. 1, 2011, the entire contents of which are incorporated herein by reference.

### FIELD

Embodiments described herein relate generally to a liquid crystal display.

### BACKGROUND

In recent years, flat display apparatuses have actively been developed and, among others, liquid crystal displays are applied to various fields by making the most of features such as the light weight, thinness, low power consumption and the like. Such a liquid crystal display is configured to hold a liquid crystal layer between a pair of substrates and displays an image by controlling the percentage modulation of light passing through the liquid crystal layer by an electric field between a pixel electrode and a common electrode.

A mode in which the orientation state of a liquid crystal is controlled by applying a longitudinal electric field in a direction substantially perpendicular to substrate surfaces of a pair of substrates to the liquid crystal layer and a mode in which the orientation state of a liquid crystal is controlled by applying a transverse electric field (including a fringe electric field) in a direction substantially parallel to substrate surfaces of a pair of substrates to the liquid crystal layer have been known for the liquid crystal display.

Particularly, the liquid crystal display using a transverse electric field receives attention in terms of a wide angle of visibility. A liquid crystal display in transverse electric field mode such as In-Plane Switching (IPS) mode or Fringe Field Switching (FFS) mode includes a pixel electrode and a common electrode formed on a first substrate.

In a liquid crystal display in IPS mode, the pixel electrode and the common electrode are arranged side by side by being spaced in a direction substantially parallel to a substrate surface and the orientation state of liquid crystal molecules is controlled by a transverse electric field generated between the pixel electrode and the common electrode.

### BRIEF DESCRIPTION OF THE DRAWINGS

FIG. 1 is a diagram schematically showing a configuration example of a liquid crystal display according to an embodiment;

FIG. 2 is a diagram schematically showing a configuration example of a display pixel of the liquid crystal display according to an embodiment;

FIG. 3 is a diagram illustrating a configuration example of the display pixel of the liquid crystal display according to a first embodiment;

FIG. 4 is a diagram illustrating a configuration example of the display pixel of the liquid crystal display according to a second embodiment;

FIG. 5 is a diagram illustrating an example of an electric field screening effect of the liquid crystal display according to the first or second embodiment;

FIG. 6 is a diagram illustrating a configuration example of the display pixel of the liquid crystal display according to a third embodiment; and

FIG. 7 is a diagram illustrating a configuration example of the display pixel of the liquid crystal display according to a fourth embodiment.

### DETAILED DESCRIPTION

In general, according to one embodiment, a liquid crystal display includes a first substrate having a scan line, a signal line crossing the scan line, a pixel electrode containing a plurality of comb pixel electrodes extending in a direction in which the signal line extends and arranged side by side in the direction in which the scan line extends, a common electrode containing a plurality of comb common electrodes extending in the direction in which the signal line extends between the plurality of comb pixel electrodes and arranged with a predetermined space to the comb pixel electrodes, and a shielding portion arranged at least between the signal line and the comb pixel electrodes arranged near the signal line and to which a same voltage as that of the common electrode is applied, a second substrate arranged opposite to the first substrate, and a liquid crystal layer sandwiched between the first substrate and the second substrate.

Liquid crystal displays in the embodiments will be described below with reference to the drawings.

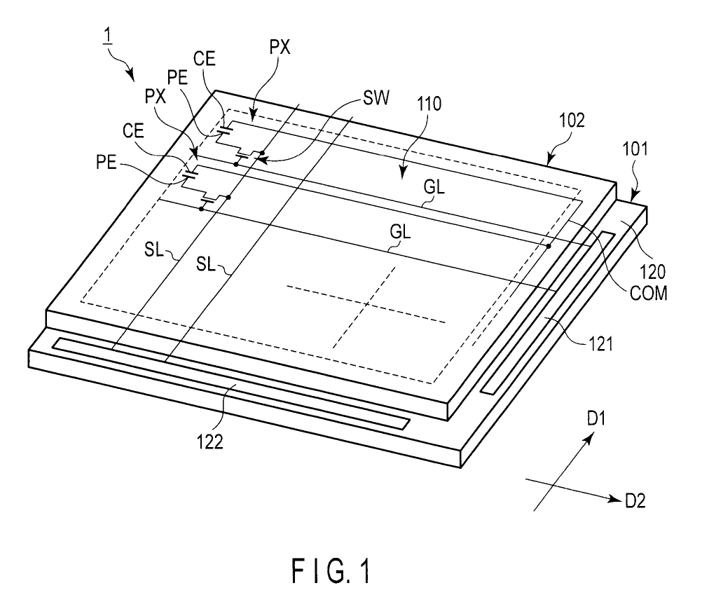

FIG. 1 schematically shows a configuration example of a liquid crystal display 1 according to the first embodiment. The liquid crystal display 1 according to the present embodiment is a normally black liquid crystal display in IPS mode and includes a pair of substrates opposite to each other, that is, a first substrate 101 and a second substrate 102, a liquid crystal layer (not shown) sandwiched between the first substrate 101 and the second substrate 102, and a display unit 110 containing display pixels PX arranged in a matrix shape.

The first substrate 101 and the second substrate 102 are optically transparent insulating substrates and, for example, glass substrates.

The first substrate 101 includes a plurality of scan lines GL extending along a row direction (second direction) D2 in which the display pixels PX are arranged, a plurality of signal lines SL extending along a column direction (first direction) D1 in which the display pixels PX are arranged, a pixel switch SW arranged near an intersection position of the scan line GL and the signal line SL, a plurality of pixel electrodes PE arranged in each display pixel PX, and a common electrode CE arranged so as to form a transverse electric field in a space between the plurality of pixel electrodes PE and the common electrode CE in the display unit 110.

A gate driver 121 and a source driver 122 are arranged in regions on the first substrate 101 around the display unit 110. The plurality of scan lines GL extends to regions around the display unit 110 to connect to the gate driver 121. The plurality of signal lines SL extends to regions around the display unit 110 to connect to the source driver 122.

The gate driver 121 sequentially drives the plurality of scan lines GL to cause conduction between the source and drain of the pixel switch SW connected to the scan line GL. The source driver 122 supplies a video signal to the plurality of signal lines SL. The video signal supplied to the signal lines SL is supplied to the pixel electrode PE via the corresponding pixel switch. A common voltage is supplied to the common electrode CE via a common wiring line COM.

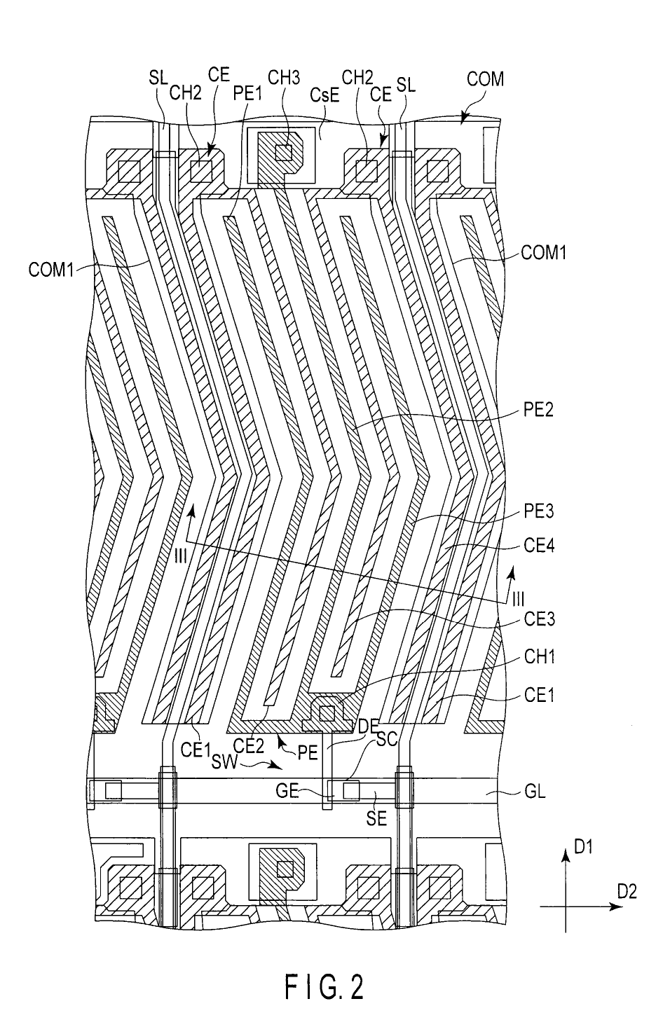

FIG. 2 shows a plan view illustrating a configuration example of the display pixel PX.

The signal line SL and the scan line GL extend so as to be intersected with each other. The pixel switch SW is, for example, a thin-film transistor containing a semiconductor layer SC of amorphous silicon. Incidentally, the pixel switch SW may be a thin-film transistor containing a semiconductor layer of polysilicon. A gate electrode GE of the pixel switch SW is electrically connected to (or integrally formed with) the corresponding scan line GL. A source electrode SE of the pixel switch SW is electrically connected to (or integrally formed with) the corresponding signal line SL. In the liquid crystal display 1 according to the present embodiment, the pixel switch SW includes two source electrodes. A drain electrode DE of the pixel switch SW is connected to the corresponding pixel electrode PE via a contact hole CH1.

The electric connection of the pixel electrode PE to the signal line SL is switched by the pixel switch SW whose gate potential is controlled by the scan line GL arranged on one side in the column direction D1. The pixel electrode PE is electrically connected to an auxiliary capacity electrode CsE arranged on the other side in the column direction D1 in a contact hole CH3.

The pixel electrode PE is formed in a comb-like shape from a transparent electrode material, for example, ITO (Indium Tin Oxide) or IZO (Indium Zinc Oxide) and includes a plurality of comb pixel electrodes PE1 to PE3 extending substantially in parallel with the column direction D1 in which the display pixel PX is arranged. The plurality of comb pixel electrodes PE1 to PE3 is bent in a substantially central portion of the display pixel PX in the longitudinal direction (column direction D1) to extend in a “>” shape.

The common electrode CE is formed in a comb-like shape from a transparent electrode material, for example, ITO (Indium Tin Oxide) or IZO (Indium Zinc Oxide) and includes a plurality of comb common electrodes CE1 to CE4 extending substantially in parallel with the column direction D1 in which the display pixel PX is arranged. The plurality of comb common electrodes CE1 to CE4 is bent in a substantially central portion of the display pixel PX in the longitudinal direction (column direction D1) to extend in a “>” shape. The common electrode CE is electrically connected to the common wiring line COM described later in a contact hole CH2.

The signal line SL is depicted as a substantially straight line in FIG. 1, but as shown in FIG. 2, the signal line SL extends, like the shape of the comb pixel electrodes PE1 to PE3 of the pixel electrode PE and the comb common electrodes CE1 to CE4 of the common electrode CE, by being bent in a substantially central portion of the display pixel PX in the longitudinal direction.

The common wiring line COM is arranged, for example, in the same layer as the scan line GL, by extending substantially in parallel with the direction (row direction D2) in which the scan line GL extends. The common wiring line COM is electrically connected to the common electrodes CE arranged in the plurality of display pixels PX aligned in the row direction D2 to apply the common voltage to these common electrodes CE.

A shielding portion COM1 is arranged in a lower layer of the signal line SL and the comb common electrodes CE1 and CE4 arranged on both sides of the signal line SL. The same voltage as that of the common wiring line COM is applied to the shielding portion COM1. Together with a light shielding layer BM of the second substrate 102 described later, the shielding portion COM1 prevents light from passing through between the display pixels PX and also blocks out a leakage electric field from the signal line SL.

The auxiliary capacity electrode CsE is arranged opposite to the common wiring line COM. The auxiliary capacity electrode CsE is arranged in the same layer as the signal line SL and is electrically connected to the comb pixel electrode PE2 as one comb pixel electrode of the pixel electrode PE by the contact hole CH3. An auxiliary capacity Cs is formed between the auxiliary capacity electrode CsE and the common wiring line COM.

The comb pixel electrodes PE1 to PE3 of the pixel electrode PE and the comb common electrodes CE1 to CE4 of the common electrode CE are alternately arranged by providing a predetermined space therebetween in the row direction D2 in which the display pixels PX are arranged (or a direction substantially perpendicular to the signal line SL).

In the display unit 110, the second substrate 102 includes the light shielding layer BM arranged in a lattice shape opposite to the signal line SL and the scan line GL and a light shielding layer (not shown) arranged so as to surround the display unit 110. If the liquid crystal display is of the color display type, the second substrate 102 includes a color filter layer (not shown).

The color filter layer includes a red color filter (not shown) that allows light of red dominant wavelengths to pass through, a green color filter (not shown) that allows light of green dominant wavelengths to pass through, and a blue color filter (not shown) that allows light of blue dominant wavelengths to pass through. Each of color filters of a plurality of colors is arranged opposite to the pixel electrode PE.

A pair of alignment layers (not shown) opposite to each other via the liquid crystal layer is arranged on the first substrate 101 and the second substrate 102. The surface of the alignment film has orientation treatment such as rubbing treatment and optical orientation treatment applied thereto in a predetermined direction to regulate the initial orientation state of liquid crystal molecules contained in the liquid crystal layer. The orientation state of the liquid crystal layer is controlled by a transverse electric field generated by a potential difference between a video signal supplied to the comb pixel electrodes PE1 to PE3 and the common voltage supplied to the comb common electrodes CE1 to CE4.

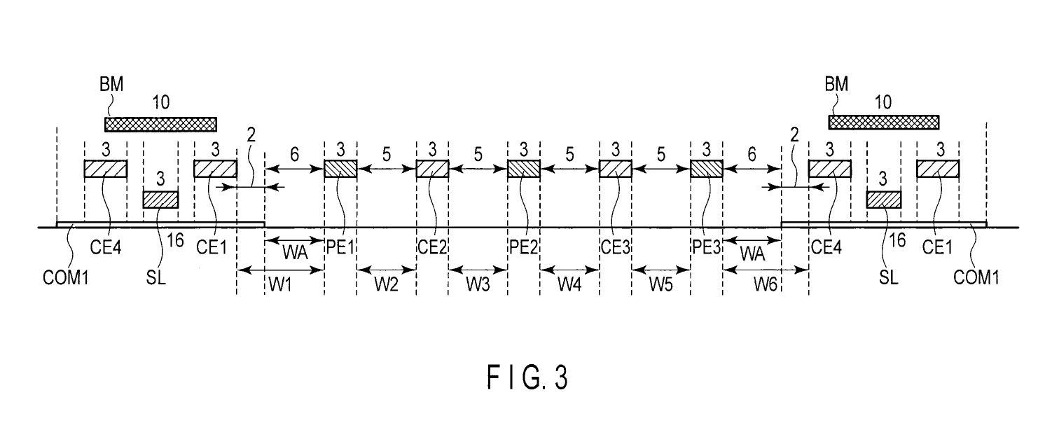

FIG. 3 is a sectional view illustrating a configuration example of the liquid crystal display 1 according to the present embodiment along a line III-III in FIG. 2. The line III-III is in a direction substantially perpendicular to the direction in which the comb pixel electrodes PE1 to PE3 and the comb common electrodes CE1 to CE4 extend. In FIG. 3, the shielding portion COM1, the comb pixel electrodes PE1 to PE3 of the pixel electrode PE, the comb common electrodes CE1 to CE4 of the common electrode CE, the signal line SL, and the light shielding layer BM are shown and other components are omitted.

In the direction in which the III-III extends, the width of the comb pixel electrodes PE1 to PE3 and the comb common electrodes CE2, CE3 is approximately 3 μm, the width of the comb common electrodes CE1, CE4 arranged on both sides of the signal line SL is approximately 3 μm, and the width of the comb signal line SL is approximately 3 μm.

The width of the shielding portion COM1 is approximately 16 μm. The shielding portion COM1 is arranged in a lower layer of the comb common electrodes CE1, CE4 and the signal line SL. In the direction in which the line extends, both ends of the shielding portion COM1 are positioned between the comb common electrode CE1 and the comb pixel electrode PE1 and between the comb common electrode CE4 and the comb pixel electrode PE3. The shielding portion COM1 is at the same potential as the common electrode CE. By arranging the shielding portion COM1 opposite to the signal line SL, a leakage electric field from the signal line SL can be blocked out and also the vicinity of the signal line SL can be shielded from light.

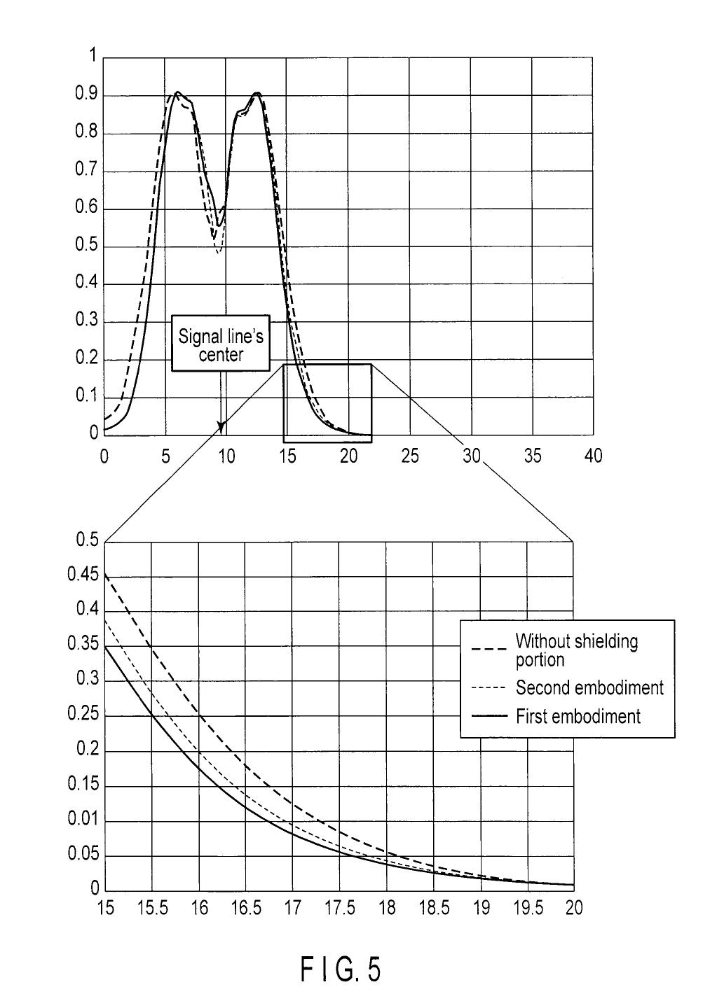

FIG. 5 is a diagram illustrating an example of an electric field screening effect of the liquid crystal display 1 according to the present embodiment. The horizontal axis of the graph shown in FIG. 5 represents the position [μm] of the display pixel PX in a direction substantially parallel to the line the vertical line represents the transmittance, and the position of the center of the signal line SL is indicated by an arrow.

In FIG. 5, the transmittance when the shielding portion COM1 is not arranged for comparison and the transmittance when the shielding portion COM1 is arranged are shown and the transmittance near the position where an end of the shielding portion COM1 is arranged in the present embodiment is enlarged. The example shown in FIG. 5 is the transmittance when the black display is made.

In both cases, the transmittance near the signal line SL is larger than in other regions and decreases with an increasing distance from the signal line SL. If the transmittance near the position where an end of the shielding portion COM1 is arranged is compared, the transmittance when the shielding portion COM1 is arranged is smaller than the transmittance when the shielding portion COM1 is not arranged.

Thus, a leakage electric field from the signal line SL can be blocked out by arranging the shielding portion COM1 at the same potential as the common electrode CE in a lower layer of the signal line SL in the present embodiment and the width thereof can be made smaller than when a member to which no voltage is applied is arranged as the shielding portion. Therefore, according to the present embodiment, a liquid crystal display in excellent display quality can be provided by avoiding a lower aperture ratio.

Incidentally, it is desirable for the shielding portion COM1 to have a sufficient width to block out a leakage electric field from the signal line SL. On the other hand, if the width of the shielding portion COM1 is increased, the aperture ratio decreases and thus, it is desirable to design the width of the shielding portion COM1 by considering the effect of being able to block out a leakage electric field and the aperture ratio.

In a liquid crystal display using a transverse electric field such as the IPS mode, the orientation state of the liquid crystal is disturbed if the screen thereof is pressed. If the orientation state of the liquid crystal is disturbed by pressing a region to which a strong electric field is applied, a domain where the orientation state of the liquid crystal is not restored to its original state after the pressing is stopped may arise. That is, if the distance between the shielding portion COM1 and the comb pixel electrodes PE1, PE3 is small, a region to which a large electric field is locally applied may arise. In such a region, a domain is more likely to occur by pressing and a portion in which the orientation state of the liquid crystal in the display pixel PX is not controlled is generated so that display unevenness or lower brightness may be caused, leading to lower display quality.

If a space width WA between the shielding portion COM1 and the comb pixel electrodes PE1, PE3 is increased, the occurrence of domain can be inhibited, but the width in which an electrode can be moved is limited by the width of the display pixel and if space widths W2 to W5 between the comb pixel electrodes PE1 to PE3 and the comb common electrodes CE1 to CE4 become narrower, a domain is similarly more likely to occur by pressing.

Thus, in the present embodiment, the occurrence of domain by pressing in the whole display pixel PX is made inhibitable by adequately blocking out a leakage electric field from the signal line SL by arranging the shielding portion COM1 to inhibit the decrease of the aperture ratio and also by increasing the space width WA between the shielding portion COM1 and the comb pixel electrodes PE1, PE3.

In the example shown in FIG. 3, the space width WA between the shielding portion COM1 and the comb pixel electrodes PE1, PE3 is desirably 4.5 μm or more and 9 μm or less.

As a result of increasing the width of the shielding portion COM1 and the space width WA sufficiently large and also inhibiting the occurrence of domain by pressing in the whole display pixel PX, the space width between the comb pixel electrodes PE1 to PE3 of the pixel electrode PE and the comb common electrodes CE1 to CE4 of the common electrode CE is different in the present embodiment between the pixel center and pixel ends in the direction in which the line III-III extends.

In the present embodiment, the space widths W1, W6 between the comb pixel electrodes PE1, PE3 and the comb common electrodes CE1, CE4 near the signal line SL in the direction in which the line III-III extends are larger than the space widths W2, W3, W4, W5 between the comb pixel electrodes PE1 to PE3 and the comb common electrodes CE2, CE3 in the center between the adjacent signal lines SL in the row direction D2.

The space widths between the comb pixel electrodes PE1, PE3 and the comb common electrodes CE1, CE4 near the signal line SL in the direction in which the line III-III extends are the space width W6 between the first comb common electrode CE4 and the first comb pixel electrode PE3 and the space width W1 between the fourth comb common electrode CE1 and the third comb pixel electrode PE1 from the side of the signal line SL that supplies a video signal to the pixel electrode PE via the pixel switch SW.

In the example shown in FIG. 3, an end of the shielding portion COM1 is positioned between the comb common electrodes CE1, CE4 and the comb pixel electrodes PE1, PE3 and thus, the space widths W1, W6 are larger than at least the space width WA.

That is, in each display pixel PX, the space width W1 between the comb common electrode CE1 arranged by the signal line SL to supply a video signal to the pixel electrode PE of the adjacent display pixel PX and the comb pixel electrode PE1 arranged next to the comb common electrode CE1 and the space width W6 between the comb common electrode CE4 arranged by the signal line SL to supply a video signal to the pixel electrode PE of the local display pixel PX and the comb pixel electrode PE3 arranged next to the comb common electrode CE4 are larger than the space width W2 between the comb pixel electrode PE1 and the comb common electrode CE2, the space width W3 between the comb common electrode CE2 and the comb pixel electrode PE2, the space width W4 between the comb pixel electrode PE2 and the comb common electrode CE3, and the space width W5 between the comb common electrode CE3 and the comb pixel electrode PE3. The space width W1 between the comb common electrode CE1 and the comb pixel electrode PE1 and the space width W6 between the comb pixel electrode PE3 and the comb common electrode CE4 are the same.

More specifically, in the present embodiment, the space width WA between the shielding portion COM1 and the comb pixel electrodes PE1, PE3 is approximately 6 μm and the space widths W1, W6 at ends of the display pixel PX are approximately 8 μm. In contrast, the space widths W2 to W5 in the center of the display pixel PX are approximately 5 μm.

Thus, by making the space width between the comb pixel electrodes PE1 to PE3 of the pixel electrode PE and the comb common electrodes CE1 to CE4 of the common electrode CE larger at pixel ends than in the pixel center in the direction in which the line III-III extends, the space width WA between the shielding portion COM1 and the comb pixel electrodes PE1, PE3 can be increased. If the space width WA between the shielding portion COM1 and the comb pixel electrodes PE1, PE3 is increased, the occurrence of domain at pixel ends can be inhibited. Therefore, according to the present embodiment, a liquid crystal display in better display quality can be provided by inhibiting the occurrence of domain.

Next, the liquid crystal display 1 according to the second embodiment will be described with reference to the drawings. In the description that follows, the same reference numerals are attached to the same components in the above first embodiment and the description thereof is omitted.

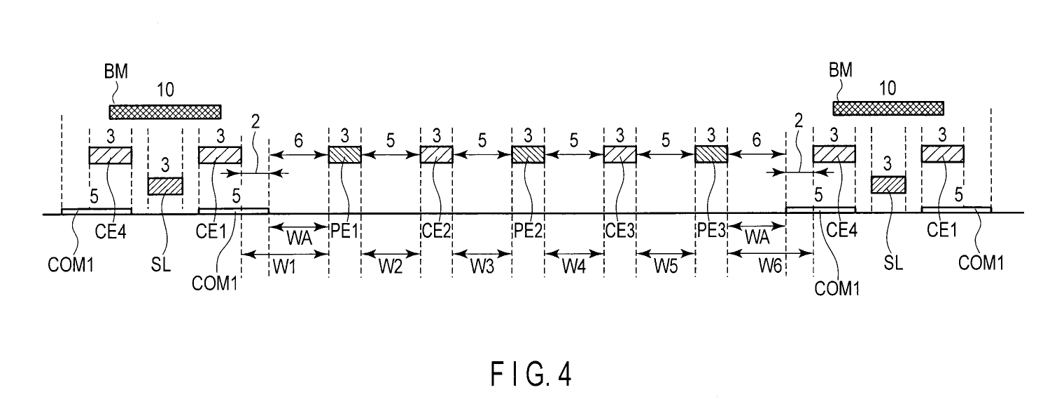

FIG. 4 is a sectional view illustrating a configuration example of the liquid crystal display 1 according to the present embodiment along the line III-III in FIG. 2. The liquid crystal display according to the present embodiment is different from the above first embodiment in the configuration of the shielding portion COM1.

The shielding portion COM1 is arranged on both sides of the signal line SL in the direction in which the line extends in a lower layer of the signal line SL and a portion thereof opposite to the signal line SL is eliminated. Therefore, the shielding portion COM1 is arranged opposite to the comb common electrodes CE1, CE4 arranged on both sides of the signal line SL. The shielding portions COM1 arranged on both sides of the signal line SL each has a width of approximately 5 μm and the width of approximately 6 μm containing a portion opposite to the signal line SL is eliminated.

If the shielding portion COM1 of the portion opposite to the signal line SL is eliminated, a short between the signal line SL and the shielding portion COM1 due to a defect of a dielectric film formed between the signal line SL and the shielding portion COM1 or static electricity can be avoided so that yields can be improved.

FIG. 5 shows an example of the electric field screening effect of the liquid crystal display 1 according to the present embodiment. If the transmittance near the position where an end of the shielding portion COM1 is arranged is compared, the transmittance when the shielding portion COM1 is arranged is smaller than the transmittance when the shielding portion COM1 is not arranged. The portion containing a position opposite to the signal line SL and from which the shielding portion COM1 is eliminated is shielded by the light shielding layer BM from light and will not be visually recognized even if the transmittance of the portion is higher than that of other portions.

Thus, a leakage electric field from the signal line SL can be blocked out by arranging the shielding portion COM1 at the same potential as the common electrode CE on both sides of the signal line SL in a lower layer of the signal line SL in the present embodiment and the width thereof can be made smaller than when a member to which no voltage is applied is arranged as the shielding portion. Therefore, according to the present embodiment, a liquid crystal display in excellent display quality can be provided by avoiding a lower aperture ratio.

Also in the present embodiment, like in the above first embodiment, the occurrence of domain is inhibited by increasing the space width WA between the shielding portion COM1 and the comb pixel electrodes PE1, PE3 and a liquid crystal display in better display quality can be provided.

Next, the liquid crystal display 1 according to the third embodiment will be described with reference to the drawings. In the description that follows, the same reference numerals are attached to the same components in the above first and second embodiments and the description thereof is omitted.

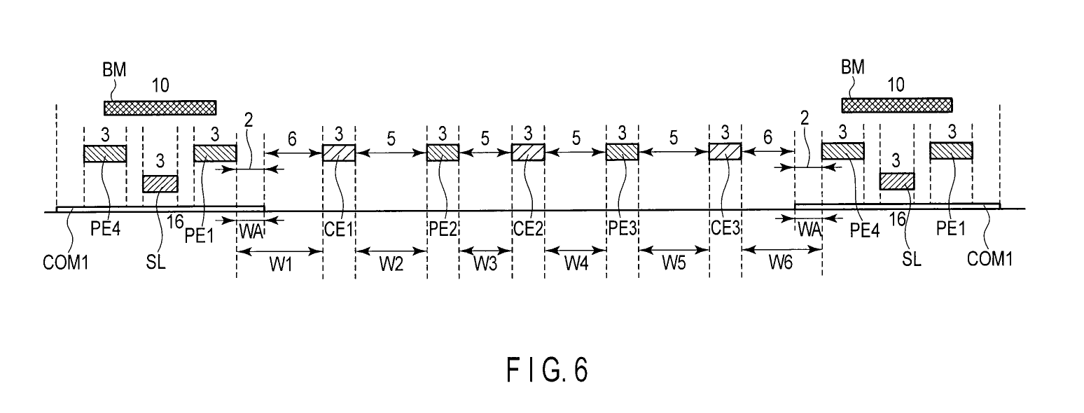

FIG. 6 is a sectional view illustrating a configuration example of the liquid crystal display 1 according to the present embodiment along the line III-III in FIG. 2. The liquid crystal display 1 according to the present embodiment is different from the above first and second embodiments in the configuration of the comb pixel electrode and the comb common electrode.

In the present embodiment, the order of arrangement of the comb pixel electrode and the comb common electrode is different in a direction substantially parallel to the line III-III. That is, in the present embodiment, the comb pixel electrode is arranged on both sides of the signal line SL in a direction substantially parallel to the line III-III.

That is, the comb pixel electrode PE4, the comb common electrode CE3, the comb pixel electrode PE3, the comb common electrode CE2, the comb pixel electrode PE2, the comb common electrode CE2, and the comb pixel electrode PE1 are arranged in this order from the side of the signal line SL that supplies a video signal to the pixel electrode PE of the local display pixel PX toward the side of the signal line SL that supplies a video signal to the pixel electrode PE of the adjacent display pixel PX.

In the present embodiment, the width of the comb pixel electrodes PE2, PE3 and the comb common electrodes CE1 to CE3 in a direction substantially parallel to the line III-III is approximately 3 μm and the width of the comb pixel electrodes PE1, PE4 is approximately 3 μm. The space widths W1 to W6 between the comb pixel electrodes PE1 to PE4 and the comb common electrodes CE1 to CE3 in a direction substantially parallel to the line III-III are approximately 5 μm.

The shielding portion COM1 is arranged opposite to the signal line SL and the comb pixel electrodes PE1, PE4 in a lower layer of the signal line SL.

In the present embodiment, like in the above first embodiment, a leakage electric field from the signal line SL can be blocked out by arranging the shielding portion COM1. Therefore, according to the present embodiment, a liquid crystal display in excellent display quality can be provided by avoiding a lower aperture ratio.

In this example, the space width between the comb pixel electrodes PE1 to PE4 and the comb common electrodes CE1 to CE3 is the same in the pixel center and at pixel ends and the space WA between the comb pixel electrodes PE1, PE4 arranged at pixel ends and the shielding portion COM1 is approximately 2 μm. In this case, the comb pixel electrodes PE1, PE4 arranged at pixel ends are arranged opposite to the shielding portion COM1 and thus, even if a domain arises due to a strong electric field between the comb pixel electrodes PE1, PE4 and the shielding portion COM1, the comb pixel electrodes PE1, PE4 are a region shielded by the shielding portion COM1 and will not be visually recognized. Therefore, according to the present embodiment, a liquid crystal display in better display quality can be provided by avoiding being visually recognized.

Next, the liquid crystal display 1 according to the fourth embodiment will be described with reference to the drawings. In the description that follows, the same reference numerals are attached to the same components in the above first to third embodiments and the description thereof is omitted.

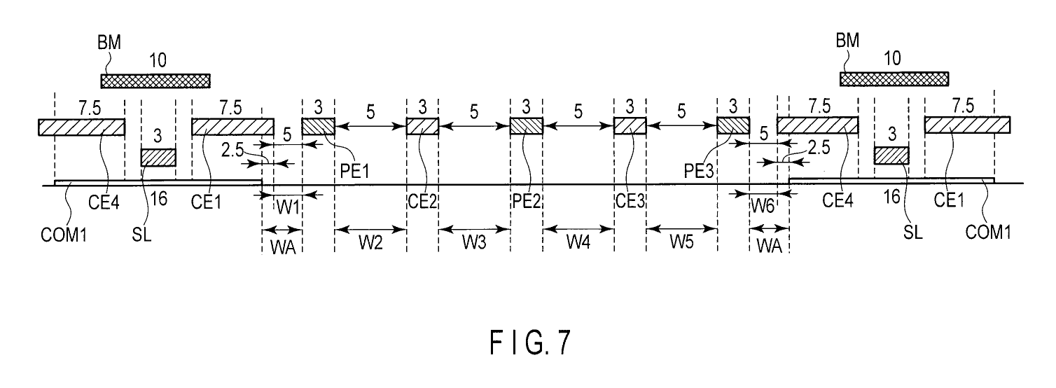

FIG. 7 is a sectional view illustrating a configuration example of the liquid crystal display 1 according to the present embodiment along the line III-III in FIG. 2. The liquid crystal display 1 according to the present embodiment is different from the above first embodiment in the configuration of the comb common electrodes CE1, CE4 arranged on both sides of the signal line SL in the direction substantially parallel to the line III-III.

In the present embodiment, the width of the comb common electrodes CE1, CE4 in the direction substantially parallel to the line III-III is larger than in the above first embodiment and approximately 7.5 μm. The space width W1 between the comb common electrode CE1 and the comb pixel electrode PE1 and the space width W6 between the comb common electrode CE4 and the comb pixel electrode PE3 are smaller than the space width WA between the shielding portion COM1 and the comb pixel electrode PE1.

In this example, the space width W1 between the comb common electrode CE1 and the comb pixel electrode PE1 and the space width W6 between the comb common electrode CE4 and the comb pixel electrode PE3 are approximately 2.5 μm and the space width WA between the shielding portion COM1 and the comb pixel electrode PE1 is approximately 5 μm. That is, the shielding portion COM1 is arranged opposite to portions of the comb common electrodes CE1, CE4 and the signal line SL in a lower layer of the signal line SL.

In the present embodiment, like in the above first embodiment, a leakage electric field from the signal line SL can be blocked out by arranging the shielding portion COM1. Therefore, according to the present embodiment, a liquid crystal display in excellent display quality can be provided by avoiding a lower aperture ratio.

Also according to the present embodiment, the ends of the comb common electrodes CE1, CE4 are positioned closer to the comb pixel electrodes PE1, PE3 than the end of the shielding portion COM1 and an electric field from the shielding portion COM1 is blocked out by the comb common electrodes CE1, CE4 and thus, the occurrence of a domain due to a strong electric field between the shielding portion COM1 and the comb common electrodes CE1, CE3 is inhibited. In this example, by setting the space width (WA−W1) between the end of the shielding portion COM1 and the ends of the comb common electrodes CE1, CE4 to 2 μm or more and 3.5 μm or less, an electric field from the shielding portion COM1 is blocked out so that the occurrence of domain due to a strong electric field can effectively be inhibited. Therefore, according to the present embodiment, a liquid crystal display in better display quality can be provided by inhibiting the occurrence of domain.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal display, comprising:
a first substrate including a scan line, a signal line crossing the scan line, a pixel electrode comprising a plurality of comb pixel electrodes extending in a direction in which the signal line extends and arranged side by side in the direction in which the scan line extends, a common electrode comprising a plurality of comb common electrodes extending in the direction in which the signal line extends between the plurality of comb pixel electrodes and arranged with a predetermined space to the comb pixel electrodes, and a shielding portion arranged at least between the signal line and the comb pixel electrodes arranged near the signal line and to which a same voltage as that of the common electrode is applied;
a second substrate arranged opposite to the first substrate; and
a liquid crystal layer sandwiched between the first substrate and the second substrate.

2. The liquid crystal display according to claim 1, wherein the shielding portion is arranged in a same layer as the scan line.

3. The liquid crystal display according to claim 1, wherein the shielding portion is arranged opposite to the signal line.

4. The liquid crystal display according to claim 2, wherein the shielding portion is arranged opposite to the signal line.

5. The liquid crystal display according to claim 1, wherein the shielding portion is arranged on both sides of the signal line in the direction substantially perpendicular to the direction in which the signal line extends and
the second substrate further includes a light shielding layer arranged in a position opposite to the signal line.

6. The liquid crystal display according to claim 2, wherein the shielding portion is arranged on both sides of the signal line in the direction substantially perpendicular to the direction in which the signal line extends and
the second substrate further includes a light shielding layer arranged in a position opposite to the signal line.

7. The liquid crystal display according to claim 1, wherein the comb pixel electrode and the comb common electrode are alternately arranged in the direction substantially perpendicular to the direction in which the signal line extends and the comb common electrode is arranged on both sides of the signal line and
a space width between the comb pixel electrode and the comb common electrode arranged near the signal line in the direction substantially perpendicular to the direction in which the signal line extends is larger than that between the comb pixel electrode and the comb common electrode in a center between the adjacent signal lines.

8. The liquid crystal display according to claim 2, wherein the comb pixel electrode and the comb common electrode are alternately arranged in the direction substantially perpendicular to the direction in which the signal line extends and the comb common electrode is arranged on both sides of the signal line and
a space width between the comb pixel electrode and the comb common electrode arranged near the signal line in the direction substantially perpendicular to the direction in which the signal line extends is larger than that between the comb pixel electrode and the comb common electrode in a center between the adjacent signal lines.

9. The liquid crystal display according to claim 3, wherein the comb pixel electrode and the comb common electrode are alternately arranged in the direction substantially perpendicular to the direction in which the signal line extends and the comb common electrode is arranged on both sides of the signal line and
a space width between the comb pixel electrode and the comb common electrode arranged near the signal line in the direction substantially perpendicular to the direction in which the signal line extends is larger than that between the comb pixel electrode and the comb common electrode in a center between the adjacent signal lines.

10. The liquid crystal display according to claim 4, wherein the comb pixel electrode and the comb common electrode are alternately arranged in the direction substantially perpendicular to the direction in which the signal line extends and the comb common electrode is arranged on both sides of the signal line and
a space width between the comb pixel electrode and the comb common electrode arranged near the signal line in the direction substantially perpendicular to the direction in which the signal line extends is larger than that between the comb pixel electrode and the comb common electrode in a center between the adjacent signal lines.

11. The liquid crystal display according to claim 5, wherein the comb pixel electrode and the comb common electrode are alternately arranged in the direction substantially perpendicular to the direction in which the signal line extends and the comb common electrode is arranged on both sides of the signal line and
a space width between the comb pixel electrode and the comb common electrode arranged near the signal line in the direction substantially perpendicular to the direction in which the signal line extends is larger than that between the comb pixel electrode and the comb common electrode in a center between the adjacent signal lines.

12. The liquid crystal display according to claim 6, wherein the comb pixel electrode and the comb common electrode are alternately arranged in the direction substantially perpendicular to the direction in which the signal line extends and the comb common electrode is arranged on both sides of the signal line and
a space width between the comb pixel electrode and the comb common electrode arranged near the signal line in the direction substantially perpendicular to the direction in which the signal line extends is larger than that between the comb pixel electrode and the comb common electrode in a center between the adjacent signal lines.

13. The liquid crystal display according to claim 1, wherein the comb pixel electrode and the comb common electrode are alternately arranged in the direction substantially perpendicular to the direction in which the signal line extends and the comb pixel electrode is arranged on both sides of the signal line and
the shielding portion is arranged opposite to the signal line and the comb pixel electrodes arranged on both sides of the signal line.

14. The liquid crystal display according to claim 1, wherein the comb pixel electrode and the comb common electrode are alternately arranged in the direction substantially perpendicular to the direction in which the signal line extends and the comb common electrode is arranged on both sides of the signal line and
a space width between the comb pixel electrode and the comb common electrode arranged near the signal is smaller than that between the shielding portion and the comb pixel electrode arranged near the signal line.
